(19) United States
(12) Patent Application Publication
(10) Pub. No.: US 2025/0020186 A1
(43) Pub. Date: Jan. 16, 2025

(54) MULTI-CHAMBER AIR SPRING, METHOD FOR OPERATING THE MULTI-CHAMBER AIR SPRING

(71) Applicant: Dr. Ing. h.c. F. Porsche Aktiengesellschaft, Stuttgart (DE)

(72) Inventors: Richard Legierski, Sindelfingen (DE); Micha David Imhof, Tiefenbronn (DE)

(73) Assignee: Dr. Ing. h.c. F. Porsche Aktiengesellschaft, Stuttgart (DE)

(21) Appl. No.: 18/673,477

(22) Filed: May 24, 2024

(30) Foreign Application Priority Data
Jul. 13, 2023 (DE) 10 2023 118 614.0

(51) Int. Cl. F16F 9/512; F16F 9/02

(52) U.S. Cl. CPC F16F 9/512; F16F 9/02; F16F 2222/126; F16F 2228/066

(57) ABSTRACT

A multi-chamber air spring includes a main volume, an additional volume and a switching valve. The switching valve is designed to connect the additional volume to the main volume in a first operating state of the multi-chamber air spring, and to disconnect the additional volume from the main volume in a second operating state of the multi-chamber air spring. The switching valve is designed to open in the second operating state from a first predetermined limit pressure difference between the additional volume and the main volume.

### CROSS-REFERENCE TO RELATED APPLICATION

This application claims priority to German Patent Application No. 10 2023 118 614.0, filed Jul. 13, 2023, the content of such application being incorporated by reference herein in its entirety.

### FIELD OF THE INVENTION

The invention relates to a multi-chamber air spring and a method for operating the multi-chamber air spring.

### BACKGROUND OF THE INVENTION

DE102019115383A1, which is incorporated by reference herein, discloses a self-balancing air spring with a first chamber and a second chamber, which can be connected to each other via a switching valve and a vent valve, wherein the vent valve equalizes the pressure between the first and the second chamber. In addition, a third chamber can be provided, which can be connected to the first chamber via a vent valve.

### SUMMARY OF THE INVENTION

The multi-chamber air spring described herein can be manufactured with a lower wall thickness in the air spring construction compared to conventional multi-chamber air springs and thus with lower weight, better rolling behavior and lower costs.

The multi-chamber air spring comprises a main volume and an additional volume, wherein the multi-chamber air spring comprises a switching valve, wherein the switching valve is designed to connect the additional volume to the main volume in a first operating state of the multi-chamber air spring and to disconnect the additional volume from the main volume in a second operating state of the multi-chamber air spring, wherein the switching valve is designed to open in the second operating state from a first predetermined limit pressure difference between the additional volume and the main volume.

The switching valve is preferably designed to close in the second operating state from a second predetermined limit pressure difference between the additional volume and the main volume, which is smaller than the first limit pressure difference.

Preferably, the multi-chamber air spring comprises several switching valves, wherein the switching valves are designed to connect the additional volume to the main volume in the first operating state and to disconnect the additional volume from the main volume in a second operating state, wherein at least one of the switching valves is designed to open from the first predetermined limit pressure difference and/or to close from the second limit pressure difference in the second operating state.

It may be provided that several of the switching valves are designed to open in the second operating state from the first predetermined limit pressure difference or to close from the second limit pressure difference.

A method for operating the multi-chamber air spring provides that in a first operating state of the multi-chamber air spring, the additional volume is connected to the main volume with the at least one switching valve and in a second operating state of the multi-chamber air spring, the additional volume is disconnected from the main volume with the at least one switching valve, wherein the at least one switching valve is opened in the second operating state from a first predetermined limit pressure difference between the additional volume and the main volume and/or is closed from a second predetermined limit pressure difference between the additional volume and the main volume, which is smaller than the first limit pressure difference.

### BRIEF DESCRIPTION OF THE DRAWINGS

Further advantageous embodiments will emerge from the following description and the drawings. The drawings show:

FIG. 1 depicts a schematic representation of a multi-chamber air spring,

FIG. 2 depicts a method for operating the multi-chamber air spring.

### DETAILED DESCRIPTION OF THE INVENTION

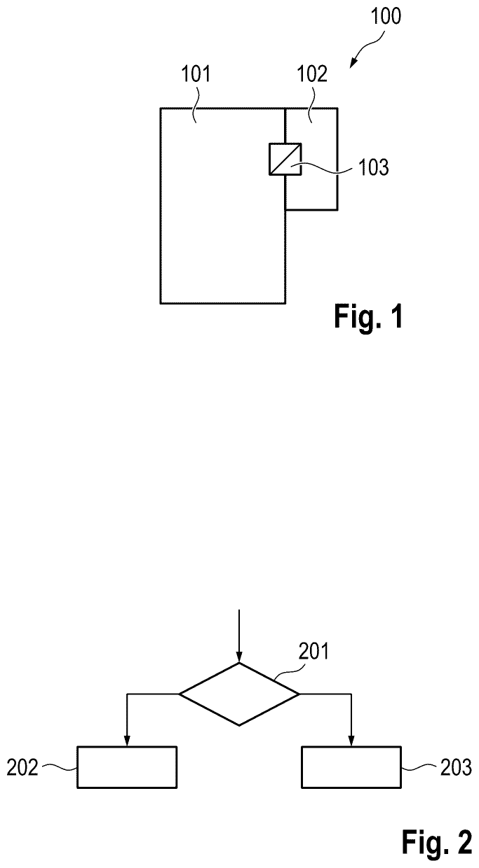

A multi-chamber air spring 100 is shown schematically in FIG. 1.

The multi-chamber air spring 100 comprises a main volume 101 and an additional volume 102.

The multi-chamber air spring 100 comprises a switching valve 103.

The switching valve 103 is designed to connect the additional volume 102 to the main volume 103 in a first operating state of the multi-chamber air spring 100. The first operating state in the example is a comfort position.

The switching valve 103 is designed to disconnect the additional volume 102 from the main volume 101 in a second operating state of the multi-chamber air spring 100. The second operating state in the example is a sport position.

During compression, the dynamic peak pressures in the multi-chamber air spring are much higher in the sport position than in the comfort position.

The switching valve 103 is designed to open in the second operating state from a first predetermined limit pressure difference between the additional volume 102 and the main volume 101. This causes air to flow from the main volume 101 into the additional volume 102. This reduces the maximum possible pressure delta between the main volume 101 and the additional volume 102. This reduces the highest pressure occurring in the main volume 101.

This serves to protect the multi-chamber air spring 100 component or the components of the multi-chamber air spring 100.

In one example, the switching valve 103 is designed to close in the second operating state from a second predetermined limit pressure difference between the additional volume and the main volume, which is smaller than the first limit pressure difference. As a result, the sport position is reset in the example after a dynamic peak pressure during compression.

The multi-chamber air spring 100 can comprise several switching valves 103, which are designed in this way. The multi-chamber air spring 100 can comprise several switching valves 103, some of which are designed in this way and some of which are not.

Part of a method for operating the multi-chamber air spring 100 is shown in FIG. 2.

The method provides that in the first operating state the additional volume 102 is connected to the main volume 103 with at least one switching valve 103 and in the second operating state the additional volume 102 is disconnected from the main volume 101 with the at least one switching valve 103. The method determines whether the limit pressure difference is greater than the first predetermined limit pressure difference or less than the second limit pressure difference (step 201). The at least one switching valve 103 is opened in the method in the second operating state from the first predetermined limit pressure difference (step 202). It may be provided that the at least one switching valve 103 is closed in the method in the second operating state from the second predetermined limit pressure difference (step 203).

What is claimed is:

1. A multi-chamber air spring comprising:
a main volume;
an additional volume; and
a switching valve that is configured (i) to connect the additional volume to the main volume in a first operating state of the multi-chamber air spring, and (ii) to disconnect the additional volume from the main volume in a second operating state of the multi-chamber air spring,
wherein the switching valve is configured to open in the second operating state at a first predetermined limit pressure difference between the additional volume and the main volume.

2. The multi-chamber air spring according to claim 1, wherein the switching valve is configured to close in the second operating state at a second predetermined limit pressure difference between the additional volume and the main volume, which is smaller than the first predetermined limit pressure difference.

3. The multi-chamber air spring according to claim 1, wherein the multi-chamber air spring comprises a plurality of the switching valves, wherein the switching valves are each configured to connect the additional volume to the main volume in the first operating state and to disconnect the additional volume from the main volume in a second operating state, wherein at least one of the switching valves is configured to open at the first predetermined limit pressure difference and/or to close at the second limit pressure difference in the second operating state.

4. The multi-chamber air spring according to claim 3, wherein the plurality of the switching valves are each configured to open in the second operating state at the first predetermined limit pressure difference or to close at the second limit pressure difference.

5. A vehicle comprising the multi-chamber air spring according to claim 1.

6. A method for operating a multi-chamber air spring comprising (i) a main volume, (ii) an additional volume, and (iii) a switching valve that is configured (a) to connect the additional volume to the main volume in a first operating state of the multi-chamber air spring, and (b) to disconnect the additional volume from the main volume in a second operating state of the multi-chamber air spring, said method comprising:
opening the switching valve in the second operating state at a first predetermined limit pressure difference between the additional volume and the main volume, and/or
closing the switching valve at a second predetermined limit pressure difference between the additional volume and the main volume, which is smaller than the first limit pressure difference.
